(19) United States
(12) Patent Application Publication
(10) Pub. No.: US 2015/0066761 A1
(43) Pub. Date: Mar. 5, 2015

(54) SELF-SERVICE MACHINE AND OPERATING METHOD OF SELF-SERVICE MACHINE

(71) Applicant: Nautilus Hyosung Inc., Seoul (KR)

(72) Inventors: Bo Ik CHANG, Seongnam-si (KR); Sung Suk HONG, Seoul (KR)

(73) Assignee: Nautilus Hyosung Inc., Seoul (KR)

(21) Appl. No.: 14/078,038

(22) Filed: Nov. 12, 2013

(30) Foreign Application Priority Data
Sep. 3, 2013 (KR) 10-2013-0105582

(51) Int. Cl. G06Q 20/10

(52) U.S. Cl. CPC G06Q 20/1085
USPC 705/43

(57) ABSTRACT

Provided is a self-service machine and operating method of the self-service machine, the self-service machine including a communication unit to receive, from a video communication server, video information on an agent terminal to be connected, in response to a video advice request, and a display unit to provide an interface including a video area in a first area divided on a screen, and display the video information executed by video communication software through the video area.

### CROSS-REFERENCE TO RELATED APPLICATION

This application claims the benefit of Korean Patent Application No. 10-2013-0105582, filed on Sep. 3, 2013, in the Korean Intellectual Property Office, the disclosure of which is incorporated herein by reference.

### BACKGROUND

1. Field of the Invention

The present invention relates to a self-service machine and operating method of the self-service machine that may provide a customer with guidelines on a method of using a service, through video communication with an agent terminal.

2. Description of the Related Art

The introduction of an automatic teller machine (ATM) has brought innovative developments in various terms with regard to financial transactions traditionally performed by clerks through windows at financial institutions. A waiting time of a customer has been reduced greatly, and financial transactions have been enabled at any time and location after business hours of a financial institution have ended. From a point of view of a financial institution, a financial service processing time has been reduced, and a reduction of manpower and expenditure has promoted an increase in work efficiency.

ATMs basically provide a number of financial tasks performed by financial institutions, for example, banks, credit unions, and the like. A user may perform desired financial transactions within a relatively short time by simply making use of an ATM installed at a bank, rather than performing the transactions through a bank clerk. The financial transactions may include a transfer, a balance inquiry, a withdrawal, a bankbook update, and the like. Due in part to such advantages of the ATM, a number of customers using ATMs, a number of ATMs installed, and a number of locations at which ATMs are installed have increased rapidly, and today ATMs are readily found at various locations.

A conventional ATM is provided along with a telephone which enables a customer to talk to a clerk at a corresponding business branch. Accordingly, the customer may report a situation via the telephone and be provided with guidelines when an error occurs during a financial transaction or when the user is unaware of a method of operating an ATM.

However, when the method of operating the ATM is explained through the telephone, the customer may experience difficulty in learning the method through voice guidance. Accordingly, there is a demand for development of technology for providing a customer with guidelines on a method of using a service in a self-service machine to be utilized by the customer to access the service, for example, an ATM, a ticket vending machine, a rewards accumulation machine, and the like.

### SUMMARY

An aspect of the present invention provides an easy-to-use self-service machine and operating method of the self-service machine that may provide, in response to an advice request from a customer, an interface for displaying video information on an agent terminal in a first area divided on a screen, and provide a financial transaction page in a second area differing from the first area, thereby enabling the customer to perform a financial transaction readily while receiving guidelines on a method of using a service from the agent terminal through video communication.

Another aspect of the present invention also provides a self-service machine and operating method of the self-service machine that may provide an interface for displaying, on a screen, video information on an agent terminal, and immediately providing guidelines on a method of using a service to a customer experiencing an issue or having an inquiry about using the self-service machine.

According to an aspect of the present invention, there is provided a self-service machine including a communication unit to receive, from a video communication server, video information on an agent terminal to be connected, in response to a video advice request, and a display unit to provide an interface including a video area in a first area divided on a screen, and display the video information executed by video communication software in the video area.

According to another aspect of the present invention, there is also provided an operating method of a self-service machine, the operating method including receiving, from a video communication server, video information on an agent terminal to be connected, in response to a video advice request, providing an interface including a video area in a first area divided on a screen, and displaying the video information executed by video communication software in the video area.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a diagram illustrating a structure of an automatic teller machine (ATM);

FIG. 2 is a block diagram illustrating a configuration of a self-service machine according to an embodiment of the present invention;

FIG. 3 is a diagram illustrating a process of providing an interface in a self-service machine according to an embodiment of the present invention;

FIGS. 4A through 5B are diagrams illustrating examples of a financial transaction using a video advice in a self-service machine according to an embodiment of the present invention; and

FIG. 6 is a flowchart illustrating an operating method of a self-service machine according to an embodiment of the present invention.

### DETAILED DESCRIPTION

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures.

A self-service device according to an embodiment of the present invention may refer to a series of devices providing various services in response to manipulation performed by a customer. For example, the self-service device may include a ticket vending machine, a rewards accumulation machine, and an automated teller machine (ATM) installed in each business branch to provide financial transaction services to a customer in response to manipulation performed by the customer. In addition, the self-service device may include terminals providing a financial transactions page to a customer accessing an Internet banking server. The terminals may include, for example, a computer, a laptop computer, a smart phone, a tablet personal computer (PC), and the like.

Hereinafter, for ease of description, an ATM providing a financial transaction service will be referred to as a self-service machine.

The term “ATM” used herein may include a general ATM, a cash dispenser (CD) enabling cash withdrawal, and an automated complex machine providing various financial services, for example, banking, insurance, credit cards, and the like. In addition, the “ATM” may include a series of automated machines such as a kiosk providing various additional services, for example, bill payment, ticket issuance, point accumulation, and the like.

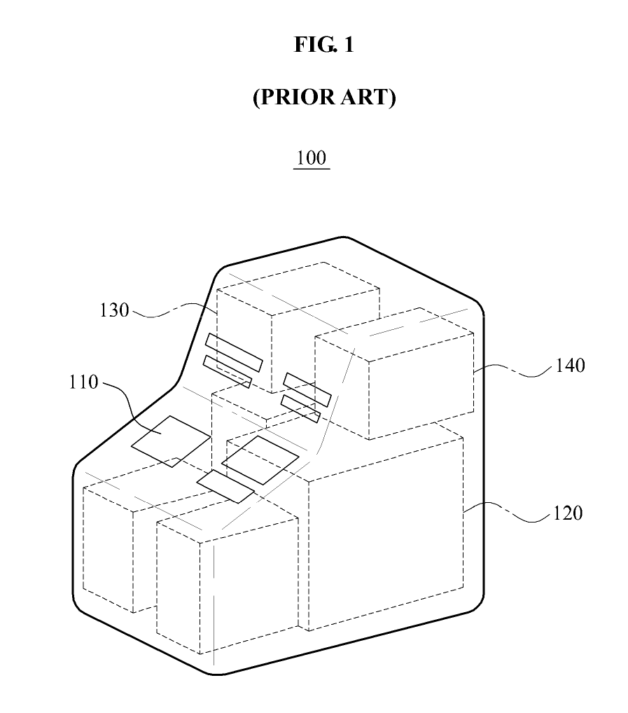

FIG. 1 is a diagram illustrating a structure of an ATM 100.

Referring to FIG. 1, the ATM 100 may include an operation terminal unit 110, a banknote deposit and withdrawal unit 120, a bankbook unit 130, and a card reader 140.

The operation terminal unit 110 may receive inputs of menu selection and manipulation for a financial transaction from a customer, and provide various financial services or additional services to the customer through a graphical user interface (GUI) screen.

The banknote deposit and withdrawal unit 120 may count and store banknotes. The bankbook unit 130 may read a bankbook and perform a banknote update task. The card reader 140 may read a card when the customer inserts a financial transaction card, and perform a card-related task. The card reader 140 may read the financial transaction card, a rewards card for other tasks, an identification (ID) card, and the like.

In addition, the ATM 100 may further include a communication unit configured to access an automatic teller server, a control unit configured to control an overall operation of the ATM 100, a memory configured to store data, a print module configured to print transaction particulars on a bankbook or a receipt, and the like.

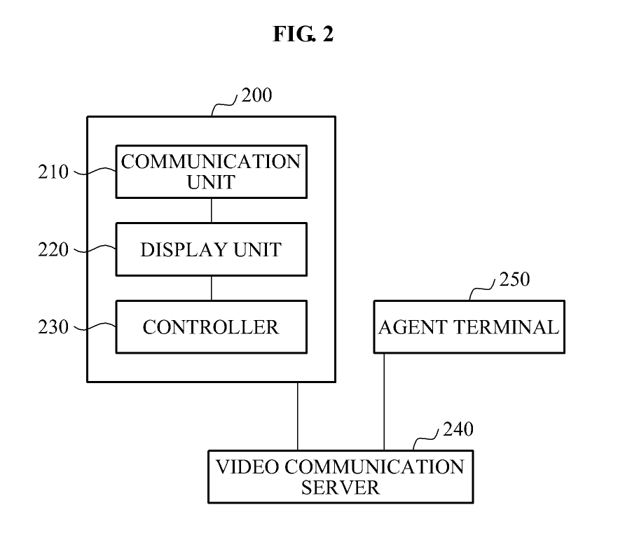

FIG. 2 is a block diagram illustrating a configuration of a self-service machine 200 according to an embodiment of the present invention.

Referring to FIG. 2, the self-service machine 200 may include a communication unit 210, and a display unit 220. The self-service machine 200 may further include a controller 230, depending on an embodiment.

The communication unit 210 may receive, from a video communication server 240, video information on an agent terminal 250 to be connected, in response to a video advice request.

As an example, when a financial transactions page is displayed on a screen, the self-service device 200 may also display a video advice request menu to support video communication with an agent. As another example, the self-service machine 200 may include an input button to support the video communication with the agent. When the video advice request menu or the input button is selected by the customer, a video advice request may be made in the self-service machine 200 and the communication unit 210 may transfer the video advice request to the video communication server 240.

The video communication server 240 may connect the self-service machine 200 in which the video advice request is made to the agent terminal 250, receive video information generated by a camera module installed in the agent terminal 250, and transmit the received video information to the self-service machine 200. As described above, the self-service machine 200 may perform video communication with the agent terminal 250 via the video communication server 240, when a video advice request is made by a customer. Accordingly, the customer may request video communication with an agent conveniently at any time when the customer has a problem or an inquiry during a financial transaction.

As an example, the video advice request may be made when a user performing a financial transaction does not provide a touch input on the screen within a predetermined time. For example, when an action, for example, a touch input with respect to the screen, an insertion of a card or a bankbook to a card slot or a bankbook slot, or a push input with respect to the input button, is not sensed within a predetermined time, for example, 30 seconds, the self-service machine 200 may output a voice guidance message saying “Please click the voice advice request menu at the screen bottom to learn how to use ATM”. When the customer hearing the voice guidance message selects the video advice request menu, the video advice request may be made in the self-service machine 200. As another example, the video advice request may be made when a financial transaction is initiated in the self-service machine 200, for example, when a financial transaction selection page is displayed.

The display unit 220 may provide an interface including a video area, in a first area divided on the screen, and display the video information executed by video communication software through the video area.

For example, when the video advice request is input by the customer, the display unit 220 may divide the screen using various schemes, for example, into left and right portions, or upper and lower portions, set one of the divided portions to be the first area, and simultaneously execute the video information using the video communication software.

In this example, the display unit 220 may provide an execution view of the video communication software, in particular, the interface in the first area, adjust a size and a position of the video area of the interface, and display the video information to match the video area. The video information may include images and sounds generated by the agent terminal 250.

In addition, the display unit 220 may provide a financial transactions page in a second area divided on the screen, when the interface is provided in the first area. The second area may differ from the first area. When a control menu for video advice termination is selected or when the financial transaction is terminated, the display unit 220 may provide a full screen view of the financial transactions page, similar to the original financial transactions page before the video advice request was made.

Here, the financial transactions page may include one of a financial transaction selection page, a transaction confirmation page, a denomination selection page, and a receipt issuance selection page. In particular, the customer may easily perform, based on an explanation of the agent, a transaction, for example, select a financial transaction in the second area of the screen, confirm a transaction, select a denomination, or select whether a receipt is to be issued, through the interface including the video area provided in the first area of the screen.

Herein, the video communication software may include general-purpose video conference software supporting video communication with the agent terminal 250. Accordingly, in the execution view of the video communication software, in particular, the interface, various input user interfaces (UIs) may be provided, separately from the video area. The input UIs may include, for example, “pause”, “double speed playback”, and the like. The display unit 220 may provide, in the first area, control menus including at least one of a size adjustment menu, a volume adjustment menu, and a video advice termination menu with respect to the video information.

Accordingly, in order for the customer not to confuse the input UIs with the control menus, the display unit 220 may display a remaining area, excluding the video area from the interface, to be opaque, thereby preventing a touch input with respect to the input UIs.

Depending on an embodiment, the self-service machine 200 may further include the controller 230 to prevent the video information from being changed although the customer confuses the input UIs with the control menus and incorrectly selects the input UIs. The controller 230 may invalidate a touch input sensed in the first area. In particular, the controller 230 may invalidate the touch input sensed in the first area, excluding the control menus and the video area. Accordingly, although a touch input with respect to the input UIs, for example, “pause”, “double speed playback”, and the like, is sensed, the controller 230 may prevent changes, for example, suspension of play of the video information, or accelerated play of the video information.

As an example, the controller 230 may provide a layer to invalidate the touch input sensed in the first area, when the interface is provided in the first area. For example, the controller 230 may optically provide the layer with respect to the screen implemented by a touch screen. In addition, the layer may be provided physically on the screen in a form of a film to invalidate a touch input of the customer.

As described above, according to an embodiment of the present invention, by providing an interface displaying video information on an agent terminal on a screen, in response to a video advice request from a customer, guidelines on a method of using a service may be provided for better understanding of the customer through a support of video communication with an agent terminal. Accordingly, the customer may easily perform a financial transaction through a financial transactions page provided in a second area differing from a first area, while receiving the guidelines on the method of using a service from the agent terminal through video communication using the interface provided in the first area divided on the screen.

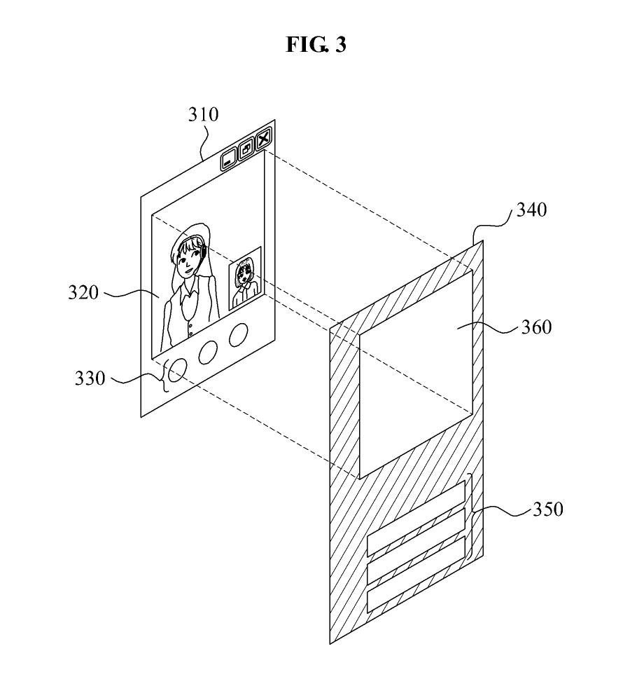

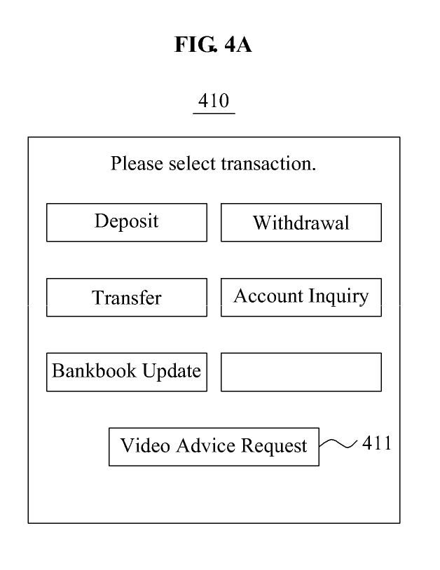

FIG. 3 is a diagram illustrating a process of providing an interface in a self-service machine according to an embodiment of the present invention.

Referring to FIG. 3, the self-service machine may support video communication with an agent terminal, using general-purpose video conference software. In particular, the self-service machine may provide an interface 310 in which the general-purpose video conference software is executed, in a first area divided on a screen.

In this instance, the interface 310 may include a video area 320 to which matching video information is displayed. In addition, the interface 310 may include various input UIs 330, for example, “pause”, “double speed playback”, and the like, separately. Since the self-service machine may provide control menus with respect to the video information in the first area, separately, a customer may confuse the input UIs with the control menus and incorrectly select the input UIs. Accordingly, the self-service machine may provide a layer 340 to optically invalidate a touch input sensed in the first area, when the interface 310 is provided in the first area. In this instance, the self-service machine may control the layer 340 not to be provided in a portion 350 in which the control menus are disposed and a portion 360 matching the video area 320.

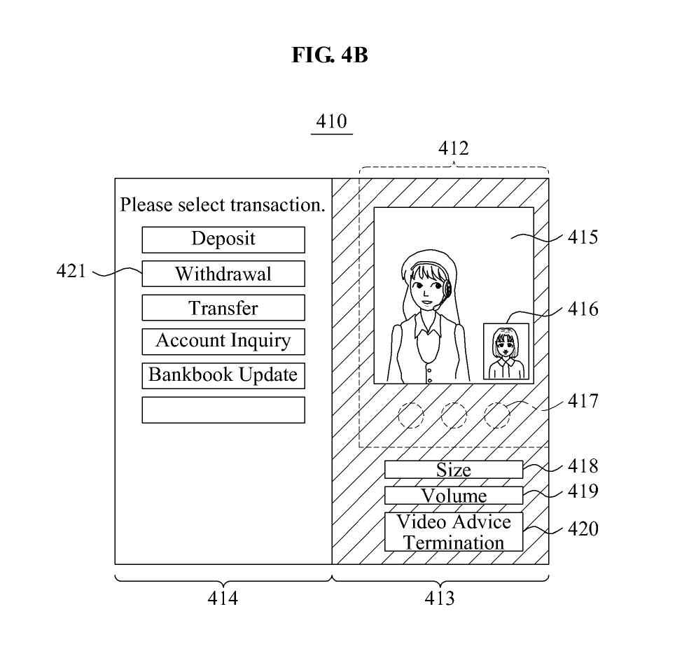

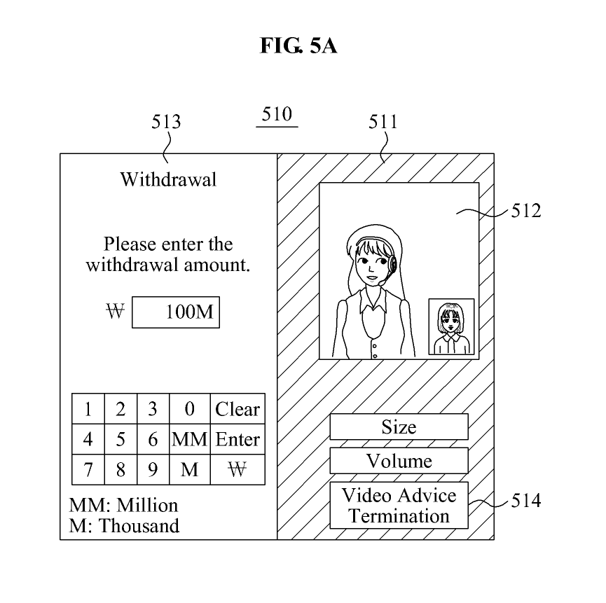

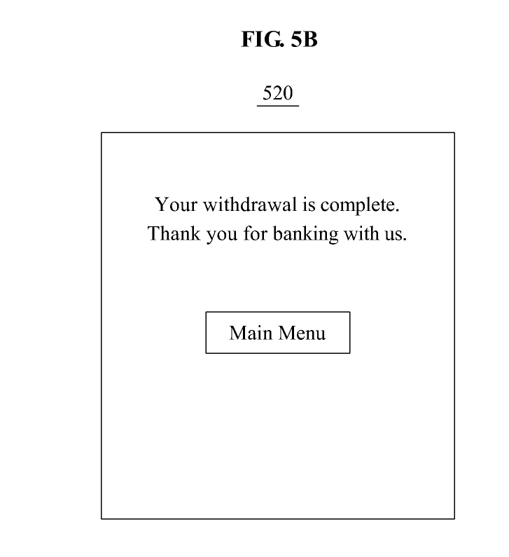

FIGS. 4A through 5B are diagrams illustrating examples of a financial transaction using a video advice in a self-service machine according to an embodiment of the present invention.

FIG. 4A illustrates an example of a financial transaction selection page. The self-service machine may display, on a screen 410, the financial transaction selection page, along with a video advice request menu 411 to support video communication with an agent. When the video advice request menu 411 is selected by a customer, a video advice request may be made in the self-service machine.

FIG. 4B illustrates an example of the screen 410 divided into a first area 413 and a second area 414 in response to the video advice request.

When the video advice request menu 411 is selected by the customer, the self-service machine may divide the screen 410 into a left portion and a right portion, and set the right portion to be the first area 413 and the left portion to be the second area 414.

The self-service machine may provide an interface 412 including a video area 415 in the first area 413, and display video information on an agent terminal through the video area 415.

In this instance, in the video area 415, video information 416 of the customer photographed by a camera module connected to the self-service device may be displayed concurrently. In addition, the self-service machine may transmit the video information 416 of the customer to the agent terminal over a communication network.

The interface 412 may correspond to an execution view of general-purpose video conference software. Accordingly, various input UIs 417, for example, “pause”, “double speed playback”, and the like, may be provided in the interface 412, separately from the video area 415. However, since control menus 418, 419, and 420 to perform at least one of size adjustment with respect to the video information, volume adjustment, and video advice termination are additionally provided in the first area 413, the self-service machine may prevent a touch input with respect to the input UIs 417 by displaying a remaining area, excluding the video area 415 and the control menus 418, 419, and 420 from the interface 412, to be opaque, in order to prevent confusion between the input UIs 417 and the control menus 418, 419, and 420.

In addition, the self-service machine may provide a financial transactions page in the second area 414. The financial transactions page may include a financial transaction selection page including, for example, a “withdrawal” menu 421, as shown in FIG. 4B. The financial transactions page may include a withdrawal page, as shown in FIG. 5A.

FIG. 5A illustrates an example of a withdrawal page with a video advice service.

FIG. 5B illustrates an example of a full screen view 520 of a financial transaction page displayed when a withdrawal is complete.

A customer may easily perform a withdrawal in a second area 513 of a screen 510, based on an explanation of an agent through a video area 512 provided in a first area 511 of the screen 510. In this example, when the withdrawal is terminated, or when a control menu, for example, a video advice termination menu 514, displayed in the first area 511 is selected, the self-service machine may provide the full screen view 520 of the financial transaction page, for example, a transaction completion page, as shown in FIG. 5B, similar to the original financial transactions page before the video advice request was made.

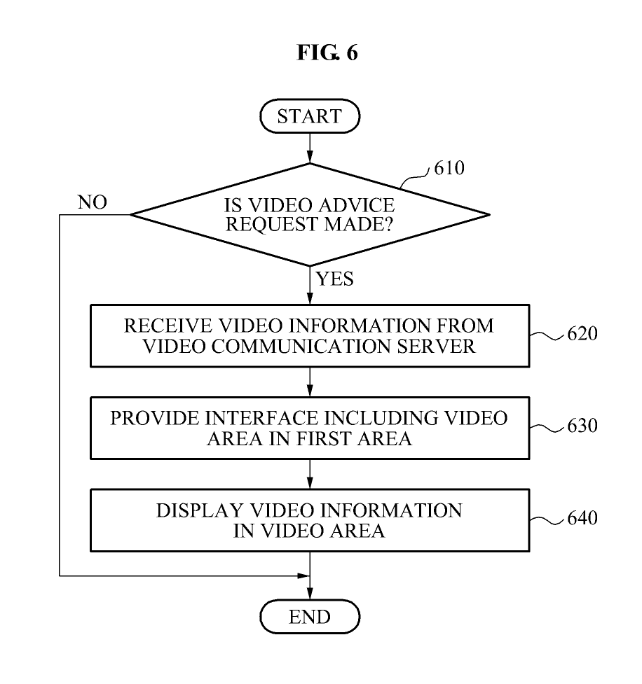

FIG. 6 is a flowchart illustrating an operating method of a self-service machine according to an embodiment of the present invention.

Referring to FIG. 6, in operation 610, the self-service machine may verify whether a video advice request is made. In operation 620, the self-service machine may receive video information on an agent terminal to be connected, in response to the video advice request.

The video advice request may be made when a user performing a financial transaction does not provide a touch input on a screen within a predetermined time.

For example, when an action, for example, a touch input with respect to the screen, an insertion of a card or a bankbook to a card slot or a bankbook slot, or a push input with respect to an input button, is not sensed within a predetermined time, for example, 30 seconds, the self-service machine may output a voice guidance message saying “Please click the voice advice request menu at the screen bottom to learn how to use ATM”. When the customer hearing the voice guidance message selects a video advice request menu, the video advice request may be made in the self-service machine.

In operation 630, the self-service machine may provide an interface including a video area, in a first area divided on the screen. In operation 640, the self-service machine may display the video information executed by video communication software through the video area.

In addition, the self-service machine may provide a financial transactions page in a second area divided on the screen when the interface is provided in the first area. The second area may differ from the first area.

The video communication software may include general-purpose video conference software supporting video communication with the agent terminal. Accordingly, in an execution view of the video communication software, in particular, the interface, various input UIs may be provided, separately from the video area. The input UIs may include, for example, “pause”, “double speed playback”, and the like. The self-service machine may provide, in the first area, control menus including at least one of a size adjustment menu, a volume adjustment menu, and a video advice termination menu with respect to the video information.

Accordingly, in order for a customer not to confuse the input UIs with the control menus, the self-service machine may display a remaining area, excluding the video area from the interface, to be opaque, thereby preventing a touch input with respect to the input UIs. Also, the self-service machine may provide a layer to optically invalidate a touch input sensed in the first area, when the interface is provided in the first area.

As described above, according to an embodiment of the present invention, by displaying video information on an agent terminal through an interface provided on a screen in response to a video advice request from a customer, guidelines on a method of using a service may be provided to the customer through video communication with the agent terminal.

According to an embodiment of the present invention, there is provided an easy-to-use self-service machine and operating method of the self-service machine that may provide, in response to an advice request from a customer, an interface for displaying video information on an agent terminal in a first area divided on a screen, and provide a financial transaction page in a second area differing from the first area, thereby enabling the customer to easily perform a financial transaction while receiving guidelines on a method of using a service from the agent terminal through video communication.

According to another embodiment of the present invention, there is also provided a self-service machine and operating method of the self-service machine that may provide an interface for displaying, on a screen, video information on an agent terminal, and immediately providing guidelines on a method of using a service to a customer experiencing an issue or having an inquiry about using the self-service machine.

The above-described exemplary embodiments of the present invention may be recorded in non-transitory computer-readable media including program instructions to implement various operations embodied by a computer. The media may also include, alone or in combination with the program instructions, data files, data structures, and the like. Examples of non-transitory computer-readable media include magnetic media such as hard disks, floppy disks, and magnetic tape; optical media such as CD ROM discs and DVDs; magneto-optical media such as floptical discs; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. A self-service machine comprising:
a communication unit to receive, from a video communication server, video information on an agent terminal to be connected, in response to a video advice request; and
a display unit to provide an interface comprising a video area in a first area divided on a screen, and display the video information executed by video communication software through the video area.

2. The self-service machine of claim 1, wherein the display unit adjusts a size and a position of the video area for the video information to be displayed to match the video area.

3. The self-service machine of claim 1, further comprising:
a controller to invalidate a touch input sensed in the first area.

4. The self-service machine of claim 1, wherein the display unit displays a remaining area, excluding the video area from the interface, to be opaque.

5. The self-service machine of claim 1, wherein the display unit provides, in the first area, control menus comprising at least one of a size adjustment menu, a volume adjustment menu, and a video advice termination menu with respect to the video information.

6. The self-service machine of claim 1, wherein:
the interface is provided in the first area, and
the display unit provides a financial transactions page in a second area divided on the screen, the second area differing from the first area.

7. The self-service machine of claim 6, wherein, when the video advice termination menu is selected or when a financial transaction is terminated, the display unit provides a full screen view of the financial transactions page.

8. The self-service machine of claim 6, wherein the financial transactions page comprises one of a financial transaction selection page, a transaction confirmation page, a denomination selection page, and a receipt issuance selection page.

9. The self-service machine of claim 1, wherein the video communication software comprises general-purpose video conference software supporting video communication with the agent terminal.

10. The self-service machine of claim 1, wherein the video advice request is made when a user performing a financial transaction does not provide a touch input on the screen within a predetermined time.
